(19) United States
(12) Patent Application Publication
(10) Pub. No.: US 2012/0032974 A1
(43) Pub. Date: Feb. 9, 2012

(54) METHOD AND APPARATUS FOR MAP PANNING RECALL

(76) Inventor: PHILLIP C. LYNCH, Arlington, MA (US)

(21) Appl. No.: 12/850,023

(22) Filed: Aug. 4, 2010

(51) Int. Cl. G09G 5/00

(52) U.S. Cl. 345/619

(57) ABSTRACT

Example embodiments of the present invention relate to computer-based map pan recall. A computer-based map panning with recall apparatus includes a display, a panning module, and a pan recall module. The display displays a first location of a moving object on a map. The panning module transitions display of the map from the first location to a second location remote from the first location. The pan recall module recalls display of the second location from the first location and can continue to toggle back and forth between displaying at the first location and displaying at the second location.

### BACKGROUND

Moving map displays are becoming very common in aircraft, automobiles, and other vehicles as aids to situational awareness and navigation. In addition to relatively static map data such as terrain, fixed cultural items, and navigational aids, more dynamic data such as current weather and traffic conditions are being overlaid on these maps. Tools for manipulating (e.g., zooming, re-orienting, panning) these displays so as to enhance their usefulness are also undergoing continual development.

### SUMMARY

A method and corresponding apparatus according to an example embodiment of the present invention relates to computer-based recall of a panned map. A computer-based apparatus for recalling a panned map includes a display, a panning module, and a pan recall module. The display displays a first location of an object on a map. The panning module transitions display of the map from the first location to a second location remote from the first location and back to the first location. After the display is transitioned back to displaying the first location, the pan recall module recalls display of the second location from display of the first location.

Another example embodiment of the present invention relates to a computer-implemented method and corresponding computer-based apparatus that changes display of a map from a first location represented by a first marker to a second location remote from the first marker. The example embodiment assigns a second marker to the second location, returns the display of the map back to the first location, and toggles between displaying at the first marker and displaying at the second marker.

The moving object may be displayed on the map using a marker placed at the first location. The display may represent movement of the moving object by moving the map with respect to the marker.

The panning module may transition display of the map to the second location by temporarily pausing movement of the map with respect to the marker. The panning module may store a latitude and a longitude of the second location. The panning module may store at least one of an orientation of the map, scale of a map display, and items selected for display on the map (e.g., weather, traffic, navigational aids, etc.).

After recalling display of the second location, the pan recall module may change display of the second location back to the first location after a predetermined period of time or upon receiving a request signal from a user. The pan recall module may recall display of the second location upon receiving a request signal from a user. A pan recall key may be activated to signal the pan recall module to recall displaying of the second location. The pan recall module may recall the display of the second location based on the stored latitude and longitude. The pan recall module may include a memory cache for storing the latitude and longitude of the second location. The pan recall module may continuously update position of the second location and maintain the position at a fixed distance and a fixed bearing with respect to heading or track of a marker at the first location. The pan recall module may continuously update position of the second location and maintain the position at a fixed distance and a fixed direction with respect to the first location.

The moving object may be at least one of an aircraft, an automobile or vehicle, or a marine vessel. The map display may represent at least one of flight path, travel route, or sea route.

The recalled display of the second location may include at least one of weather patterns and conditions of the second location, traffic patterns of the second location, landmarks associated with the second location, wave patterns and/or sea conditions at the second location, landing conditions at the second location, political conditions including geographical borders of the second location, terrain conditions, navigational aids, and obstacles at the second location.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an example of a multi-function display that may be used with example embodiments of the present invention.

FIG. 2 is a block diagram of a management unit embodying the present invention and employing the techniques described herein.

FIG. 3A illustrates an example of transitioning a display from displaying a first location to displaying a second location according to techniques described herein.

FIG. 3B illustrates an example embodiment of the present invention.

FIG. 4 is a schematic illustration of an example embodiment of the present invention.

FIG. 5 is a high-level schematic illustration of an example embodiment of the present invention.

### DETAILED DESCRIPTION

A description of example embodiments of the invention follows.

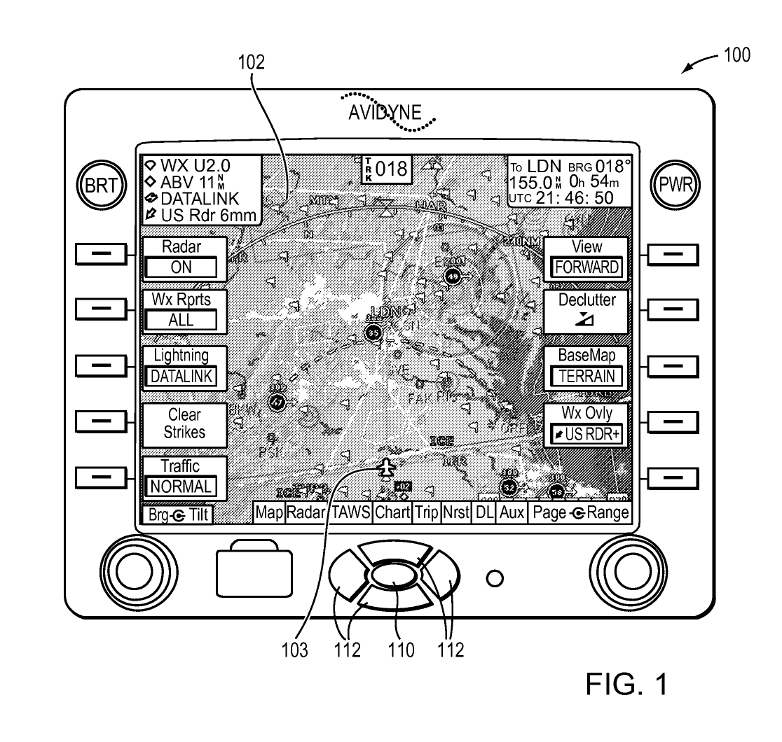

FIG. 1 is an example of a multi-function display 100 that may be used with example embodiments of the present invention. Such multi-function displays 100 may be used by/in moving objects such as aircraft, automobiles or vehicles, and marine vessels (not shown) to improve a user's ability to access and display critical travel data to enhance situational awareness. The multi-function display 100 may be used to display a moving map 102 of a travel plan and view travel data such as weather patterns, traffic patterns, landmarks, wave patterns, landing conditions, political conditions including zoning and geographical borders, navigational aids, obstacles, and terrain data. The multi-function display 100 may also provide navigational data such as heading, distance, time to arrival, and bearing data. In certain embodiments, the multi-function display 100 provides this information while displaying the moving map 102 and without needing to exit the moving map display. Accordingly, a user may continue to view his/her current location on the moving map 102 while obtaining desired travel data and safety information and without having to switch to dedicated or hidden pages.

In certain embodiments, the multi-function display 100 may serve as a radar display replacement and provide access to radar modes, and control tilt and other radar functions and parameters.

In certain embodiments, the multi-function display 100 employs a marker 103 to display the current location (with respect to surrounding objects and conditions) of a moving object to enhance situational awareness. The marker 103 may be a general marker (e.g., “X” or “O” symbol) or a shape or design that represents the nature of the moving object (e.g., an own ship symbol, an airplane for an aircraft).

In certain embodiments, the multi-function display 100 may be coupled to a database of airport diagrams (not shown). In these embodiments, the markers 103 may be used to display an aircraft position on runways, taxis, and ramps. This provides for an added measure of situational awareness during critical phases of flight and while taxiing.

Since weather and traffic (air traffic or road congestion/traffic when used in automobiles) are critical factors in successful completion of many travel plans, in certain embodiments, the multi-function display 100 may employ color lighting or color coding to demonstrate weather and/or traffic data along a travel route. For example, in certain embodiments, color red may be used to illustrate heavy traffic (moving speed of 0-10 Miles per Hour (mph)), color orange for moderate traffic (moving speed of 10-30 mph), and color green for flowing traffic (moving speed of 30-50 mph). Color coding may also be used to illustrate weather conditions. For example, color blue may be used to illustrate snowy conditions, color pink for mixed snow and rain, etc (e.g., heavier to lighter rain conditions represented by magenta, red, yellow, and green). Other colors and travel data may be illustrated and used with example embodiments of the invention. Certain embodiments may use broadcast data and two-way satellite data link to obtain the required weather data. For example, the weather data may be obtained using available resources such as the SIRIUS® Satellite Network. The multi-function display may display high-resolution NOWrad® radar mosaic, Storm Track Vectors, Hail Warnings, Airmen's Meteorological Information (AIRMET), Significant Meteorological Information (SIGMET), graphical and textual weather formats (e.g., METAR), Aviation Terminal Forecast (TAF), Temperatures and Winds Aloft, Temporary Flight Restriction (TFR), and lightning from WSI's Precision Lightning Network.

A map panning feature is used to allow a user to easily pan to any location. Specifically, the panning feature, upon activation, signals the multi-function display 100 to transition from displaying the current location of the moving object to display a new location, remote from the current location. In certain embodiments, dedicated directional panning keys 112 may be used to activate the panning feature. After displaying the new location, the multi-function display 100 returns back to displaying the current location of the moving object. This return to displaying the current location may be triggered by using a dedicated reset/pan recall key 110. In certain embodiments, the multi-function display may return to displaying the current location after a certain predetermined amount of time has lapsed. The user may toggle between displaying the current position and the panned-to position on the multi-function display 100. In certain embodiments, recalling the display of the panned-to positions may be done by activating the reset/pan key 110.

In a preferred embodiment, the reset/pan key 110 is used for toggling between displaying the current location and the prior panned-to location. In certain embodiments, multiple keys may be used (not shown).

The panning and pan recall features of the present invention facilitate recalling panned-to locations for operators of moving objects (e.g., airplane and helicopter pilots) and improve an operator's ability to access and display critical flight data. Specifically, the pan recall feature of the present invention facilitates transitions between multiple locations for operators of moving objects, thereby increasing situational awareness.

The present invention provides an operator with easier viewing of information at multiple distant locations without the inconvenience of having to reuse the pan feature to pan back to a previously panned to location. By providing the reset/pan key 110, the present invention provides a more convenient and time efficient alternative to using the pan feature.

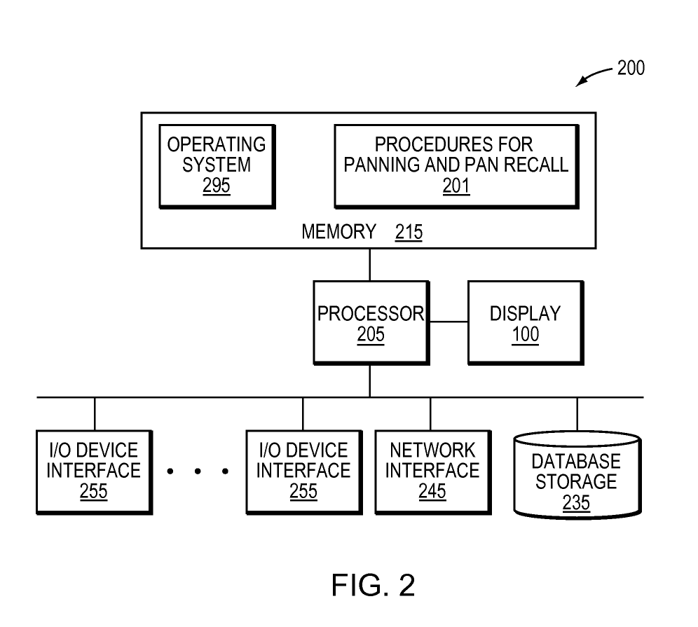

FIG. 2 is an example illustration of a management unit 200 that may utilize the techniques described herein. The components of the management unit 200 may be fully or partially placed in the multi-function display 100 or be connected to the multi-function display 100. The management unit 200 may include a memory unit 215 along with a processor 205 that may be connected to various devices via an input/output (I/O) device interface 255. The memory unit 215 may be a computer-readable memory and include combinations of non-volatile memory devices. The memory unit 215 is configured to hold various computer-executable instructions and data structures including computer-executable instructions and data structures that implement aspects of the techniques described herein.

The memory unit 215 may include a unit for procedures 201 involved in panning the display 100 from displaying a current location to displaying a new location (i.e., the panned-to location), returning the display from displaying the new location to displaying the current location, and subsequently recalling display of the panned-to location according to example embodiments of the present invention.

The memory unit 215 may also include an operating system 295 and be arranged to implement various conventional operating system functions including task and process scheduling, memory management, and controlled access to various devices, such as a database storage unit 235. The processes may include computer-executable instructions and data that are configured to implement various aspects of the techniques described herein.

The management unit 200 may also include a network interface 245 to connect the system to a network. The processor 205 may include a conventional central processing unit (CPU) comprising processing circuitry that is configured to execute various instructions and manipulate data structures from the memory unit 215.

The I/O device interfaces 255 may include logic to interface various input and/or output devices, such as a keypad or mouse, key 110 and display 100 with the processor 205. For example, control buttons 112 (shown in FIG. 1) surrounding the reset/pan recall key 110 may serve I/O device interfaces 255. The I/O device interfaces 255 may be configured to allow signals to be transferred between the management unit 200 and other components of the system.

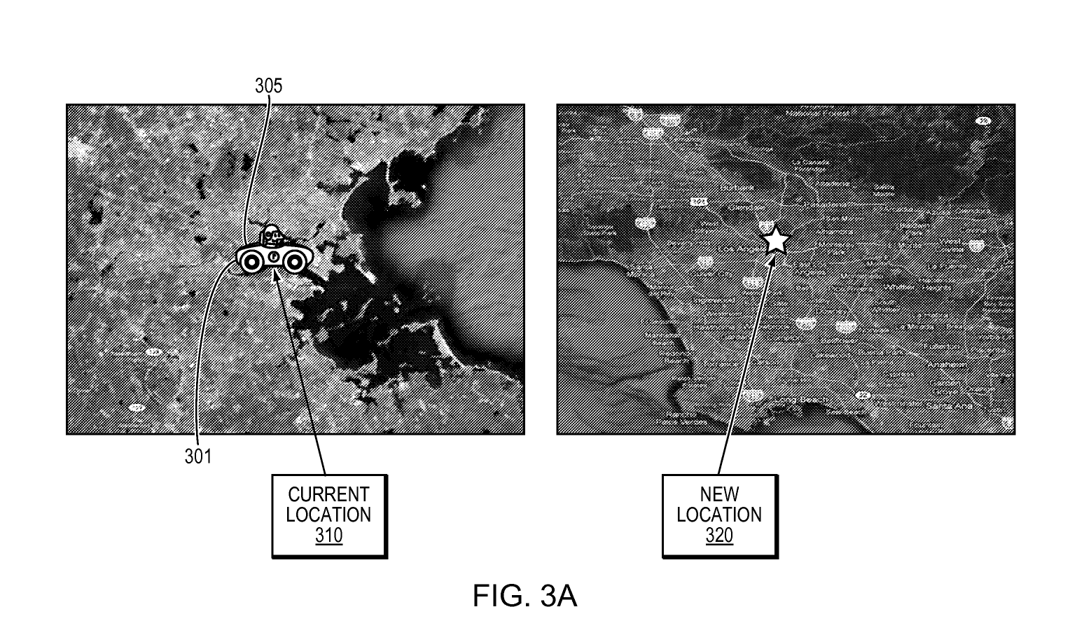

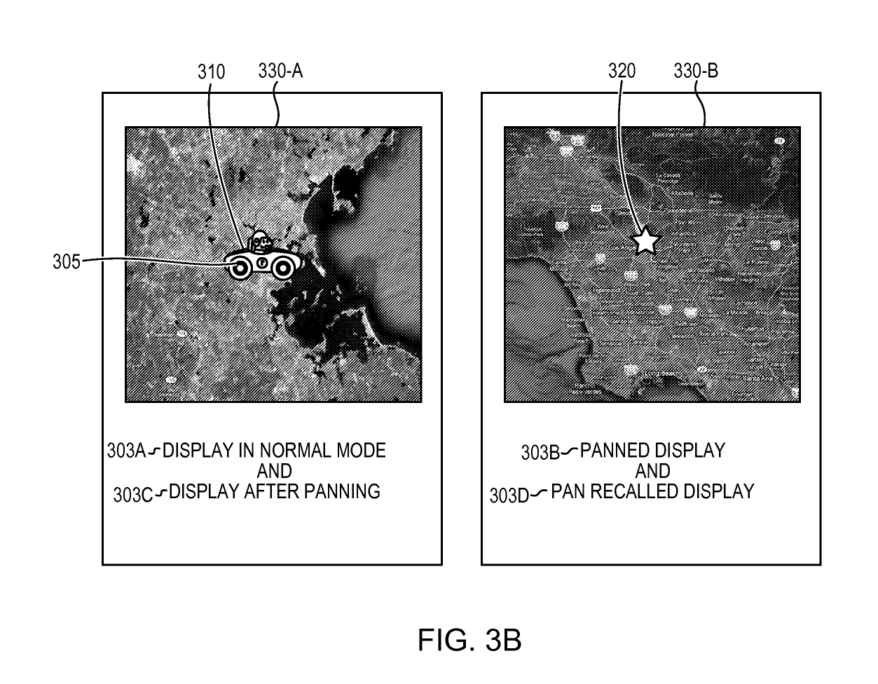

FIG. 3A illustrates an example of transitioning a display from displaying a first location 310 to displaying a second location 320 according to techniques described herein. As shown in FIG. 3A, a location of a moving object 305 (i.e., first location) may be displayed on a moving map using a marker 301. The moving map may include travel data such as weather and traffic information. The display may be transitioned to display a new location 320 (i.e., second location). The transition to the second location 320 may occur by triggering one or more keys (such as those shown as keys 112 surrounding key 110 in FIG. 1) or any other available technique in the art such as searching for the second location, determining the second location using physical address, name, latitude and longitude, etc. In a preferred embodiment, a user employs these keys 112 (shown in FIG. 1) to smoothly pan along to a desired new location 320.

Upon displaying the second location, the display transitions again and returns to displaying the first location 310. The transition back to the first location 310 may occur by activating one or more keys or using a voice command. In certain embodiments, the display may return to displaying the first location 310 after a predetermined period of time has lapsed. Once the display has returned to displaying the first location, a pan recall key 110 may be activated to return the display to displaying the new panned-to location 320.

FIG. 3B illustrates an example embodiment of the present invention. A computer-based map panning apparatus, according to example embodiments of the invention, includes a display 100 that displays a first location 310 of a moving object 305 on a map 330A, 330B. The map 330A, 330B may be a moving map in the sense that it tracks (i.e., displays) the movement of the moving object 305. For example, in certain embodiments, the moving object 305 may be displayed on the map 330A, 330B using a marker 301 placed at the first location 310, and the movement of the moving object 305 is represented by moving the map 330A, 330B with respect to the marker 301. Although the marker 301, in FIG. 3B, is shown as a symbol representing an automobile, it should be clear that any available type or shape of marker (e.g., own ship symbols, “X”, “O”, etc.) may be used to represent the moving object 305. The moving object 305 itself may be a person on foot (e.g., hikers) using the computer-based apparatus for navigation purposes or a moving vehicle such as an aircraft, an automobile, or a marine vessel. The map may represent any of a flight path, travel route, or sea route and include available travel data such as traffic patterns, landmarks, weather forecast, current weather information, wave patterns, landing conditions, and political conditions including zoning and geographical borders.

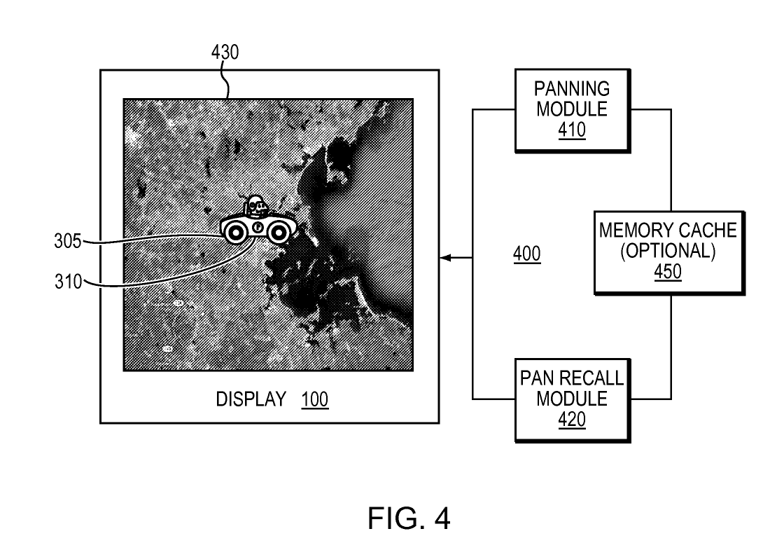

A panning module 201 (or 410, FIG. 4), upon being activated, transitions display of the map 330A from its normal mode 303-A (i.e., displaying the first location 310) to a panned display 303-B, in which a second location 320 remote from the first location 310 is displayed. The generation of the panned-to display 303-B may be activated in any possible manner available in the art. For example, the panning may be activated using one or more keys 112 (such as those shown surrounding pan recall key 110 in FIG. 1) positioned on the apparatus. In certain embodiments, the panning may be activated once a user searches or enters the latitude/longitude or other location definition (indication) of the second location 320. For example, in certain embodiments, the user may use the apparatus to search and find a landmark or a point of interest (e.g., Logan Airport, Minuteman National Park, or Main Street Café) and pan to that location to determine travel data for that location. In certain embodiments, the user may enter the physical address of the second location 320 (e.g., 123 Main Street, Boston, Mass.). In certain embodiments, the panning may be voice activated. In certain embodiments, the panning module may transition display of the map 330A to the second location 320 by temporarily pausing movement of the map with respect to the marker.

Upon panning to the new location, the apparatus may store the location data of the second location 320. For example, map orientation and/or the latitude and longitude of the second location 320 may be stored in a storage medium (e.g., memory cache).

After the display has been panned to the panned-to location 303-B, it may return to its original display mode 303-C to display the first location 310. The return to displaying the first location 310 may be triggered by pressing a key 110 or after a predetermined period of time has lapsed. The key may be the same as or different from the key used to pan to the panned-to location 320. In certain embodiments, the return to displaying the first location 310 may be voice activated. For example, the user may issue a command (e.g., “go back,” “back,” “return,” etc.) that triggers the transition of the display back to the first location 310. Other available techniques in the art (e.g., click of a mouse) may be used to transition between displaying the first 310 and second 320 locations.

After returning to displaying the first location 310 (shown in FIG. 3B as display after panning 303-C), the panned-to display 303-B may be recalled to display of the second location again (shown in FIG. 3B as pan recalled display 303-D). The recall to display the panned-to location 320 may be triggered upon receiving a signal from the user (which may be issued using techniques explained above such as activating a key 110 or through voice activation). In certain embodiments, a user may program the apparatus to toggle between display after panning 303-C and the pan recalled display 303-D over predetermined time intervals.

After recalling display of the second location 320, the apparatus may change display of the second location back to display of the first location. The apparatus may continue to toggle between the pan recalled display 303-D and display after panning 303-C. The toggling between the two displays may occur after a predetermined period of time or upon receiving a request signal from a user.

As explained above, in certain embodiments, the location information (e.g., latitude and longitude) of the panned-to location may be stored. In such embodiments, the recall to the panned-to location display 303-D may be based on the stored latitude and longitude. The apparatus may continuously update relative latitude and longitude of the second location 320 with respect to the first location 310. In certain embodiments, the bearing and distance of the second location 320 with respect to the first location 310 may be stored.

The recalled display of the second location 320 may include travel data such as weather patterns, traffic patterns, and landing conditions at the second location 320.

FIG. 4 is an illustration of an example embodiment 400 of the present invention. The example embodiment 400 includes a display 100 that displays a first location 310 of a moving object 305 on a map 430. The example embodiment 400 also includes a panning module 410 that transitions display of the map 430 from the first location 310 to a second location 320 (shown in FIGS. 3A-3B) remote from the first location. Upon displaying the second location, the panning module 410 returns the display 100 back to displaying the first location 310. The example embodiment 400 also includes a pan recall module 420 that, upon being triggered, recalls display of the second location 320 from the first location 310 by returning the display 100 to displaying the second location 320.

In certain embodiments, an optional memory unit 450 (e.g., memory cache) may be coupled with the panning module 410 and the pan recall module 420. The panning module 410 stores the last panned-to location 320 in the memory 450 (the last panned-to location may include a set of one or more panned-to locations). The pan recall module 420 fetches the stored panned-to location(s) 320 and possibly other information (such as map orientation and scale) from the memory 450. The pan recall module 420 employs this information in recalling the display of the last panned-to location(s).

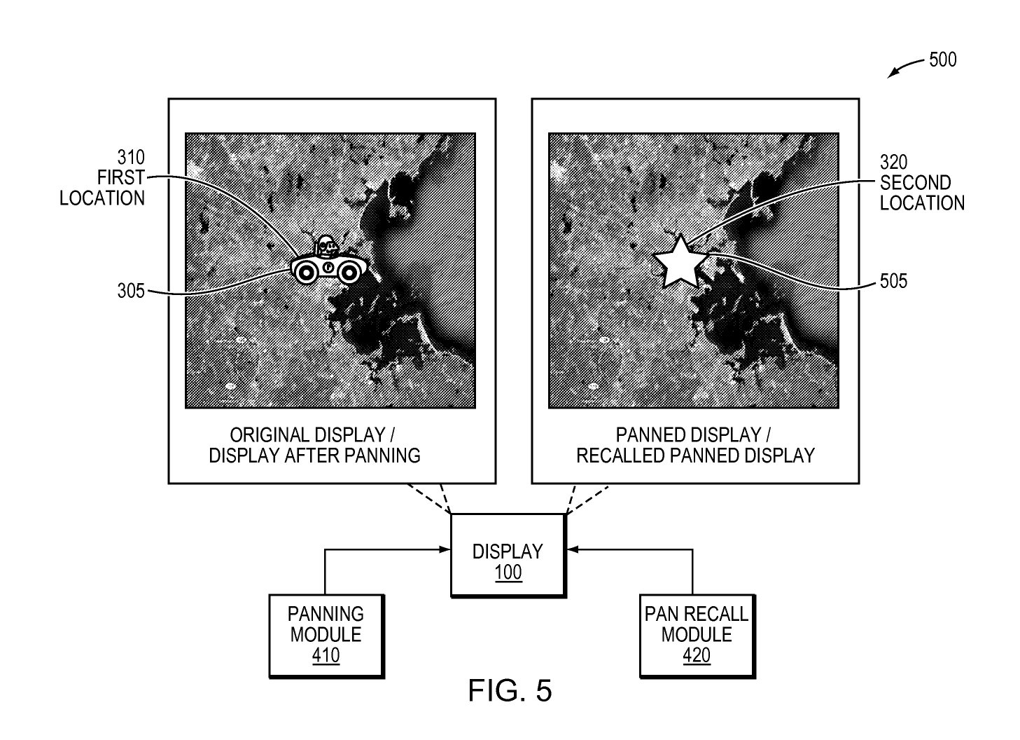

FIG. 5 is a high-level illustration of an example embodiment 500 of the present invention. The example embodiment 500 includes a panning module 410 executed by a processor that changes display 100 of a map from a first location 310 represented by a first marker 305 to a second location 320 remote from the first marker 305. The panning module 410 assigns a second marker 505 to the second location 320 and returns the display of the map back to the first location 310. The example embodiment 500 also includes a pan recall module 420 that toggles the display 100 between displaying the map at the first marker 305 and displaying a map at the second marker 505.

Embodiments of the present invention, although described for displaying a moving map, are not limited to map display and may be used in various fields requiring display of multiple targets or subjects. For example, embodiments of the present invention may be used in data processing, when working with large number of data points, to toggle between displaying various windows, views, or representation of data points.

It should be understood that procedures, such as those illustrated by flow diagrams or block diagrams herein or otherwise described herein, may be implemented in the form of hardware, firmware, or software. If implemented in software, the software may be implemented in any software language consistent with the teachings herein and may be stored on any computer readable medium known or later developed in the art. The software, typically, in form of instructions, can be coded and executed by a processor in a manner understood in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-based apparatus for recalling a panned map, comprising:
a display for displaying a first location of an object on a map;
a panning module for transitioning display of the map from the first location to a second location remote from the first location and back to the first location; and
a pan recall module configured to recall display of the second location from the first location.

2. The apparatus of claim 1 wherein the moving object is displayed on the map using a marker placed at the first location.

3. The apparatus of claim 2 wherein the display is arranged to represent movement of the object by moving the map with respect to the marker.

4. The apparatus of claim 3 wherein the panning module transitions display of the map to the second location by temporarily pausing movement of the map with respect to the marker.

5. The apparatus of claim 1 wherein after recalling display of the second location, the pan recall module further changes display of the second location back to the first location after a predetermined period of time.

6. The apparatus of claim 1 wherein after recalling display of the second location, the pan recall module further changes display of the second location back to the first location upon receiving a request signal from a user.

7. The apparatus of claim 1 wherein the pan recall module is arranged to recall display of the second location upon receiving a request signal from a user.

8. The apparatus of claim 1 further including a pan recall key that upon activation signals the pan recall module to recall displaying of the second location.

9. The apparatus of claim 1 wherein the object is at least one of an aircraft, an automobile, or a marine vessel.

10. The apparatus of claim 1 wherein the map display represents at least one of flight path, travel route, or sea route.

11. The apparatus of claim 1 wherein the panning module is arranged to store a latitude and a longitude of the second location.

12. The apparatus of claim 11 wherein the pan recall module is arranged to recall the display of the second location based on the stored latitude and longitude.

13. The apparatus of claim 11 wherein the pan recall module includes a memory cache for storing the latitude and longitude of the second location.

14. The apparatus of claim 1 wherein the pan recall module is arranged to continuously update position of the second location and maintain the position at a fixed distance and a fixed bearing with respect to heading or track of a marker at the first location.

15. The apparatus of claim 1 wherein the pan recall module is arranged to continuously update position of the second location and maintain the position at a fixed distance and a fixed direction with respect to the first location.

16. The apparatus of claim 1 wherein the recalled display of the second location includes at least one of weather patterns of the second location, traffic patterns of the second location, landmarks associated with the second location, wave patterns at the second location, landing conditions at the second location, political conditions including geographical borders of the second location, terrain conditions, navigational aids, and obstacles at the second location.

17. The apparatus of claim 1 wherein the palming module is arranged to store at least one of an orientation of the map, scale of a map display, and items selected for display on the map.

18. A computer-based method for recalling a panned map, comprising:
displaying a first location of an object on a map;
transitioning display of the map from the first location to a second location remote from the first location and back to the first location; and
recalling display of the second location from the first location.

19. The method of claim 18 further including displaying the object on the map using a marker placed at the first location.

20. The method of claim 19 further including representing movement of the object by moving the map with respect to the marker.

21. The method of claim 20 further including transitioning display of the map to the second location by temporarily pausing movement of the map with respect to the marker.

22. The method of claim 18 further including recalling display of the second location and changing display of the second location back to the first location after a predetermined period of time.

23. The method of claim 18 further including changing display of the second location back to the first location after recalling display of the second location upon receiving a request signal from a user.

24. The method of claim 18 further including recalling display of the second location upon receiving a request signal from a user.

25. The method of claim 18 further including that recalling display of the second location by activating a pan recall key.

26. The method of claim 18 wherein the moving object is at least one of an aircraft, an automobile, or a marine vessel.

27. The method of claim 18 further including displaying at least one of flight path, travel route, or sea route on the map.

28. The method of claim 18 further including storing a latitude and a longitude of the second location.

29. The method of claim 28 further including recall the display of the second location based on the stored latitude and longitude.

30. The method of claim 28 further including storing the latitude and longitude of the second location in a memory cache.

31. The method of claim 18 further including continuously updating position of the second location and maintaining the position at a fixed distance and a fixed bearing with respect to heading or track of a marker at the first location.

32. The method of claim 18 further including continuously updating position of the second location and maintaining the position at a fixed distance and a fixed direction with respect to the first location.

33. The method of claim 18 wherein the recalled display of the second location includes at least one of weather patterns of the second location, traffic patterns of the second location, landmarks associated with the second location, wave patterns at the second location, landing conditions at the second location, political conditions including geographical borders of the second location, and terrain conditions, navigational aids, and obstacles at the second location.

34. The method of claim 18 further including storing at least one of an orientation of the map, scale of a map display, and items selected for display on the map.

35. A computer apparatus comprising:
a panning module executed by a processor that changes display of a map from a first location represented by a first marker to a second location remote from the first marker, the panning module assigning a second marker to the second location and returning the display of the map back to the first location; and
a pan recall module for toggling the display between displaying at the first marker and displaying at the second marker.

36. A computer-implemented method comprising:
changing display of a map from a first location represented by a first marker to a second location remote from the first marker;
assigning a second marker to the second location and returning the display of the map back to the first location; and
toggling between displaying at the first marker and displaying at the second marker.
